(19) United States
(12) Patent Application Publication
(10) Pub. No.: US 2008/0183552 A1
(43) Pub. Date: Jul. 31, 2008

(54) METHOD FOR EVALUATING, ANALYZING, AND BENCHMARKING BUSINESS SALES PERFORMANCE

(75) Inventor: Francis E. O'Hagan, Pacific Grove, CA (US)

Correspondence Address: BEYER WEAVER LLP, P.O. BOX 70250, OAKLAND, CA, 94612-0250, US

(73) Assignee: Pied Piper Management Company

(21) Appl. No.: 11/669,023

(22) Filed: Jan. 30, 2007

(51) Int. Cl. G06F 17/30

(52) U.S. Cl. 705/10

(57) ABSTRACT

A method for evaluating a business sales environment. The method includes defining a first and second set of businesses, each forming a part of an industry. Defining a set of objective evaluation parameters suitable for evaluating a shopping experience. Weighted values are assigned to the evaluation parameters and information relevant to the evaluation parameters is obtained. Rating values are generated for at least one business of the first set of businesses and for at least one business of the second set of businesses by assessing the obtaining information in conjunction with the set of objective evaluation parameters and the associated weighting values. A report is generated that includes the compared rating values.

### TECHNICAL FIELD

The invention described herein relates generally to a method and system for evaluating businesses. More specifically, the present invention relates to a method and system for evaluating the performance of business operations through the use of data obtained by shopper evaluations, such as can be provided by, for example, anonymous shoppers. In a particular implementation, the business analysis can include creating a performance index score and using the score to compare business performance with an average for other businesses, brands, or industries of interest.

### BACKGROUND

Over the years, many different methods for evaluating business performance and customer service have been employed. Examples include direct mail surveys, mystery shopping, telephone surveys, and comment cards. However, these methods all suffer from one defect or another. For example, a mail or telephone survey is separated in time from the act it is measuring and can only indicate a customer's general evaluation of service quality. In addition, responses to phone and mail surveys are not specific to particular transactions and therefore are only of limited value. Additionally, mystery shopping (since it is a fictitious construct) does not evaluate actual sales of product. Additionally, current methods of evaluating actual customers that buy products are not well integrated into evaluations made buy customers that do not buy product. Moreover, these methods currently only measure a small number of transactions and do not address relative performance against other businesses, brands, or industries.

Thus, what is needed is a method of evaluating the sales performance of a specific group of businesses (one or many) as compared to a group of competing or similar businesses. What is further needed is a way of calibrating the evaluation such that it presents an accurate reflection of the sales performance of a given evaluated location (or group of locations). Such evaluation should enable various comparisons to be made between locations. Thus, it would be advantageous if aspects of the invention could evaluate a sales location to gauge its effectiveness as a generator of revenue. In particular, it would be advantageous if aspects of the invention could measure certain sales related parameters and the effectiveness of a sales location in meeting metrics of those parameters as compared to other comparable locations, brands, industries or other relevant comparison subjects thereby enabling an evaluation of the sales location and measuring its effectiveness as a generator of revenue. It would be further advantageous if aspects of the invention could evaluate sales locations over time, against competitors, against other industries, against other similar businesses, against other brands, and other relevant metrics.

Accordingly, the embodiments of invention present substantial advances over the existing methodologies and overcome many limitations of existing evaluation arts. These and other inventive aspects of the invention will be discussed herein below.

### SUMMARY OF THE INVENTION

In accordance with the principles of the present invention, methods for evaluating businesses and in some embodiments evaluating the sales effectiveness of businesses.

In one embodiment, the invention teaches a method for evaluating a business sales environment. The method includes defining a first and second set of businesses, each forming a part of an industry. A set of objective evaluation parameters is defined as suitable for evaluating a shopping experience. Weighted values are assigned to the evaluation parameters and information relevant to the evaluation parameters is obtained. A rating value is generated for at least one business of the first set of businesses and for at least one business of the second set of businesses by assessing the obtaining information in conjunction with the set of objective evaluation parameters and the associated weighting values. A report is generated that includes the compared rating values.

In another embodiment, the invention teaches a computer program product comprising a computer-usable medium having computer-readable code embodied thereon for invoking a method for evaluating a business sales environment and associated effects. The computer program product comprising computer-readable program code for enabling execution of the following steps within a computer system. The steps include defining a first and second set of businesses forming a part of an industry. Receiving information relevant to a set of objective evaluation parameters, the information suitable for enabling an evaluation of a shopping experience concerning the industry. Assigning weighted values to the set of objective evaluation parameters. Generating a single rating value for the first set of businesses and the second set of businesses by assessing the received information in conjunction with the set of objective evaluation parameters and the associated weighting values. Generating a report that compares rating values.

These and other aspects of the present invention are described in greater detail in the detailed description of the drawings set forth hereinbelow. Accordingly, numerous aspects of the present invention are described in detail hereinbelow.

### BRIEF DESCRIPTION OF THE DRAWINGS

The following detailed description will be more readily understood in conjunction with the accompanying drawings, in which:

FIG. 1 is a simplified flow diagram illustrating one process embodiment constructed in accordance with the principles of the invention.

FIG. 2 is a simplified block diagram illustrating certain aspects of a computer system implementation used to conduct business evaluation in accordance with the principles of the invention.

FIG. 3 is a portion of a simplified sample evaluation form completed in accordance with the principles of the invention.

FIGS. 4A, 4B, & 4C are portions of a simplified sample report comparing businesses in accordance with the principles of the invention.

It is to be understood that, in the drawings, like reference numerals designate like structural elements. Also, it is understood that the depictions in the Figures are not necessarily to scale.

### DESCRIPTION OF SPECIFIC EMBODIMENTS

The present invention has been particularly shown and described with respect to certain embodiments and specific features thereof. The embodiments set forth herein below are to be taken as illustrative rather than limiting. It should be readily apparent to those of ordinary skill in the art that various changes and modifications in form and detail may be made without departing from the spirit and scope of the invention.

The following detailed description describes various embodiments of a method and approach for conducting business evaluations based on relevant information received from a variety of sources and used to conduct analysis of a selected plurality of objective evaluation parameters.

In general the embodiments of the invention comprise a variety of methods and systems for evaluating businesses including using shopper evaluation information (which include, but are not limited to, questionnaires, mystery shopping information, surveys of actual customers, direct mail surveys, direct evaluation, expert evaluations, comment cards, telephone surveys, and so on) to provide evaluation information. For example, mystery shopping information can be obtained though the use of anonymous shoppers who, under the guise of a regular consumer of products or services, evaluate business operations and obtain relevant information.

The general idea of obtaining such information is to provide executives and managers of business operations with an essentially objective evaluation of the performance of its business operations through the analysis of data obtained. In one embodiment of the invention, the idea is to measure how well “sales factors” are executed by a business operation and how accurately the “sales factors” (or a set of objective evaluation parameters) track revenue generation (either by a customers actual propensity to buy an item or make a referral to another customer that translates into a sale). Such sales factors can include, but are not limited to, the sales environments of the sales location under evaluation and also the salesmanship of the sales staff. Executives and managers can use such objective information to assist in maintaining control of the business environment and/or the sales force operations because objective information is provided that identifies and pinpoints the causes of under-performance in a business operation. Additionally, comparisons can be made with other businesses, regions, brands, industries, and also over time, as well as other related comparisons. Embodiments of the invention can also be used to explore and compare with alternate brands, other managers, and importantly with competitors' operations.

In accordance with the present invention, data obtained includes data obtained from actual customers as well as prospective customers (which may include individuals that do not buy). In particular, the information and data includes data relevant to the sales environment of each location. Such data can include the general sales environment and/or ambience of a sales location (cleanliness, layout, availability of example merchandise, etc.) as well as the actions of the staff (e.g., staff friendliness, staff appearance, staff attitude, accessibility of the staff, product knowledge and expertise of the staff, and other staff factors) and other salesmanship factors important to the management (e.g., staff collection of prospect contact information, offering of particular product features to the prospect, overall impressions and so on). Thus, by collecting information from prospects (prospective customers) that buy items or services and by collecting information from those that do not buy, a more complete and accurate picture of the sales environment of a business can be obtained. Additionally, the evaluations can be can be repeated over specified time intervals to determine if previous problems have been corrected or to track performance over time and also to determine if negative issues have arisen over time. In particular, embodiments of the invention enable performance evaluations to be used to compare one particular business operation with others in a chain of business operations so that a multi-business operation chain can provide the same standard of salesmanship and environment in all stores thereby maintaining a competitive edge in the marketplace. Additionally, a multi-business operation chain may compare their national average performance (overall, or with respect to specific aspects) with the performance of other multi-business operation chains. Problems that cause certain business operations to be less productive or generate less revenue can be identified during the practice of this invention and, if needed, corrected.

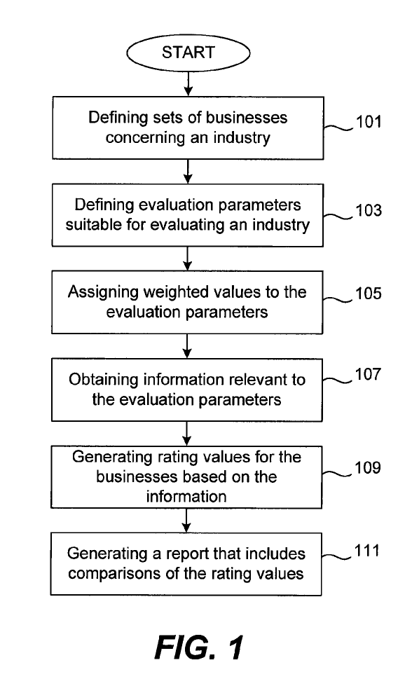

A method for evaluating a business sales environment and associated effects is described herein. Such method can include the following operations depicted in the flow diagram of FIG. 1. Defining a first and second set of businesses that form a part of an industry (Step 101). A set of objective evaluation parameters suitable for evaluating shopping experience concerning the industry is defined (Step 103). Assigning weighted values to the set of objective evaluation parameters (Step 105). Information relevant to the set of objective evaluation parameters is obtained (Step 107). Generating a rating value for at least one business of the first set of businesses and for at least one business of the second set of businesses by assessing the obtaining information in conjunction with the set of objective evaluation parameters and the associated weighting values (Step 109). Generating a report that compares the rating values (Step 111).

Referring now to the flowchart of FIG. 1, a first operation (Step 101) in a method embodiment for evaluating a business (e.g. evaluating a business sales environment or sales force or associated effects) comprises defining a first set of businesses and a second set of businesses, each forming a part of an industry. In this context “industry” is a term used broadly and flexibly. An industry can be used broadly, including for example, all brands within motor vehicle industry (i.e., all brands of car, truck, motorcycle, recreational vehicles (e.g., motor homes and the like), heavy vehicles, marine vehicles (jet skis, boats, and so on), and so on) or be selectively narrowed to encompass any selected part of the industry, in one example, an industry can define all motorcycle brands within the motorcycle industry. In short, the evaluator defines businesses in any of a number of categories that enable relevant or useful comparisons to be made.

Examples can include, but are not limited to a first set of businesses that comprise a single business (e.g., a single site (i.e., a single store or sales location)), a set of related businesses (e.g., a chain of businesses), a set of regionally related businesses (e.g., a set of businesses that define a regional locations), a set of businesses that sell a brand under evaluation. The set of business is defined in any reasonable way that enables comparison of the businesses with another set of businesses. The second set of businesses is characterized to enable meaningful comparisons with the first set of businesses. Such second set can include businesses that comprise a set of related businesses (e.g., a chain of businesses of which the business identified in the first set form a part) to which the first set of business can be compared. Also, the second set can include, a set of regionally related businesses of which the first set forms a part, a set of businesses that sell the brand under evaluation of which the first set forms a part. The second set can comprise all businesses that sell brands related to the brand under evaluation (e.g., all competitive brands in an industry). Alternatively, the second set can comprise businesses that sell merchandise in related industries (e.g., for example the first set can comprise businesses that sell the Suzuki® motorcycle brand and the second group can comprise all business that sell any motorcycle brand or alternatively all business that sell any automotive brand (GMC, Audi, Saab, Suzuki, etc) or all motor vehicle brands. Each of these groups can provide useful comparative or benchmarking information.

The inventors point out that, although not limited to such, the following comparisons can prove meaningful and helpful to an evaluation. A comparison of a single sales site (or set of related locations) as compared to other sales locations that sell the same brand, a comparison of a single sales location (or set of related locations) as compared to other sales locations that sell the same brand in the same region, a comparison of a single sales location (or set of related locations) as compared to other sales locations that sell competitive brands, a comparison of a single sales location (or set of related locations) as compared to other sales locations that sell products in an associated industry, a comparison of a first set of businesses with a second set of businesses as measured over time. The general idea contemplated by the inventor is that a set of businesses is defined in any reasonable way that enables comparison of the businesses with another set of businesses. In particular, the inventor contemplates that such comparisons can enable benchmark comparisons of a sales location with other sellers of a same brand or benchmark comparisons with other sellers of related or different brands. Thus, a merchant can effectively rate how a business is doing relative to other comparable or competitive businesses.

With further reference to FIG. 1, a set of objective evaluation parameters suitable for evaluating shopping experience concerning the industry is defined (Step 103). In general, this involves formulating essentially objective evaluation parameters for a specific business operation. This generally includes composing sets of objective queries (questions) that enable desired information to be elicited about said parameter. In one implementation, the various business operations are segmented and performance criteria created for each key area of business operation. For example, if the subject industry was grocery stores, specific areas of operation could be defined. For example, a deli department, a bakery, rest rooms, checkout and so on. Performance parameters for each key area could be established by experts in the relevant area and by using interviews with managers and executives. Queries could be formulated that elicit essentially objective answers using a shopper evaluation. In an automotive or motorcycle industry evaluation an equally relevant and specialized set of parameters can be generated. For example, a parameters can be defined that measure “sales factors”. For example, one such factor is the sales environment (what does the target location look like). Such a parameter gauges or otherwise provides a metric for the “environment” of a sales location. With some types of business operations the parameters can be measured using scientific data so that the responses are substantially objective. When evaluating a retail coffee shop, for example, the temperature of the coffee is measured using thermometers. The following includes a few examples of objective questions that may be used to rate the indicated performance parameters for the sales environment (the inventors point out that the invention covers other measures beyond those specifically enumerated here).

### EXAMPLE 1

### Signage:

Was the signage easily visible and did it make finding the location easy? Y/N

### Parking:

Was the parking area easily accessible? Y/N
Was the parking area in good condition? Y/N

### Interior:

Was the entrance clean and inviting? Y/N
Was the office areas neat and orderly? Y/N
Was your first impression of the interior a positive one? Y/N (Please fully explain your answers).

Many of the questions are phrased to require a yes or a no answer. In such a manner the questions can achieve objectivity. Thus, a shopper evaluation can provide essentially objective responses to the questions. Additionally, in some cases, qualitative information useful to a business owner, but not used to calculate a numeric score, can be can be obtained by and provided to the business owner. The inventor points out that the answers can be obtained and recorded in any suitable manner.

Referring again to FIG. 1, the defined objective evaluation parameters of a business operation can then be assigned weighted values to stress the various importance of given parameters (Step 105). Numerical ratings can be assigned to specific questions in each tested parameters. Thus, a score sheet can be evaluated using answers to the specific queries as adjusted by the weighted point system. The numerical ratings can be combined for each key area (objective parameter) to generate a single rating for that area. More important parameters are weighted higher than less important parameters. Importance can be adjusted depending on what the needs or purpose of the evaluation are. Aspects of this feature of the invention are discussed in greater detail elsewhere in this patent.

Again referring to FIG. 1, the process includes obtaining information relevant to the set of objective evaluation parameters (Step 107). This information can be obtained using a wide of sources and techniques. For example the information can be obtained using “shopper evaluations” which can include, but are not limited to, questionnaires, mystery shopping information, surveys of actual customers, shopper intercept interviews of actual shoppers, direct mail surveys, direct evaluation, expert evaluations, comment cards, telephone surveys, and so on). Mystery shopping information is obtained though the use of anonymous shoppers who, under the guise of a regular consumer of products or services, evaluate business operations. One example, methodology for conducting such mystery shopping is described in some detail in the U.S. Pat. No. 6,952,679 entitled “Method and System for Evaluating Quality Services” issued to Pulford.

The inventor points out that the answers can be obtained and recorded in any suitable manner. In the following implementation the answers can be input into an electronic or a printed form or scanned through the use of an electronic data entry device. One particularly useful implementation is an electronic implementation where the acquired data is directly entered into an electronic system (a portable computer device and the like) enabling rapid and efficient entry of the evaluation information directly into a computerized analysis system. However, one of ordinary skill will appreciate that many different approaches to such data acquisition may be employed in accordance with the principles of the invention.

The information is of course related to the evaluation parameters and the associated questions but is also tailored to the type of evaluation being conducted so, the information collected should be suitable for enabling an evaluation of a shopping experience concerning the industry. In one preferred system, collected information is particularly associated with the revenue generated or the bottom line profitability of the evaluated business. The idea being that parameters and questions bearing on profitability and revenue generation are weighted more heavily than parameters and questions that are not as closely associated with profitability and revenue generation. This will be discussed in greater detail elsewhere in this patent.

The process further includes generating a rating value (Step 109) for at least one business of the first set of businesses and also generating a rating value for at least one business of the second set of businesses by assessing the obtaining information in conjunction with the set of objective evaluation parameters and the associated weighting values. This typically means that the information obtained (in response to the questions evaluating the parameters) is used in conjunction with the assigned weighting values to generate scores for the evaluation. In one embodiment, a business under evaluation is scored based on the answers to the questions and the associated weighting values and then the total is summed to create a single value “scoring” the business in question. Additionally, the other businesses (or brands, etc) are also “scored” in a similar fashion to generate a single value rating for each of the other businesses in question.

The numerical ratings are then used to generate managerial reports (Step 111). The managerial reports can take many forms. Computer software can be used to manipulate the data to create graphs, comparison charts or straight-line reports. The rating values generated can be easily compared using the reports.

As explained above (with respect to Step 107) various parameters can be weighted in accordance with their relative importance in accord with the evaluation scheme. For example, in one system, points are weighted (e.g., in Step 107) according to a direct correlation to the revenue generation or bottom line profitability of the evaluated entity. In a particular embodiment, the points can be weighted to evaluate the sales environment of a location and the salesmanship of the staff (which also incidentally correlates with the revenue generation and profitability of the evaluated entity). Thus, rating values obtained in such an embodiment are referred to herein as a Prospect Satisfaction Index (explained in fuller detail elsewhere herein) which is a measure of the evaluated business' ability to meet the needs of potential sales prospects and also lead to the generation of revenue. Thus the values assigned to a question or parameter as well as the weighting value set to reflect those items that more directly affect profitability.

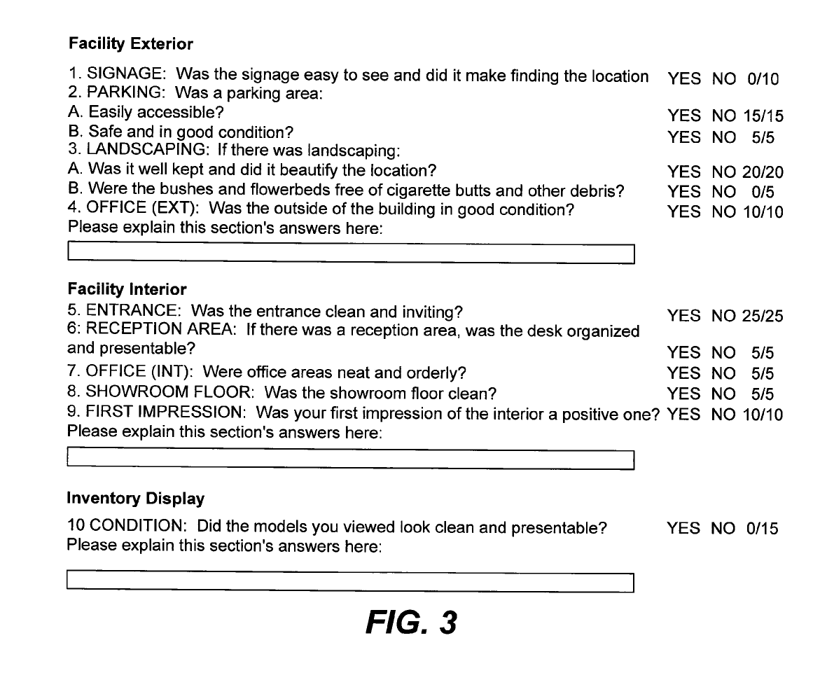

FIG. 3 is a portion of a sample evaluation form completed in accordance with the principles of the invention. The numbers to the right of the “No” column define the scored points for the specific parameters. The score sheet illustrated in FIG. 3 uses a weighted point system to arrive at the numerical rating. Items that have a greater impact on profitability are considered more important by a manager and therefore are given greater weight. This reflected by the various values listed for each question on the form. During one preferred method embodiment of this invention, the shopper evaluation results in points only for “yes” answers. The points can be tallied and then totaled for an overall numerical rating.

Additionally, and importantly similar data can be received and scored for other businesses, other brands, competitors, other associated stores and many other sources that are defined as useful by users of this invention. The collected data is also scored to provide rating values for competitive or comparative businesses, brands, and industries. This extremely valuable feature enables benchmarking of the evaluated business(s) against the other competitive or comparative businesses, brands, or industries. This sort of comparison or benchmarking as provided by an independent third party, for an entire industry, is not done currently.

Accordingly, the numerical ratings are then used to generate managerial reports that compare the rating values (Step 111). These comparison reports provide an excellent measure of how a business is meeting certain goals and standards vis a vis its associated competitors or other associated businesses. This is an important distinction between this invention and the prior art which generally does not evaluate competitors. This inventive process requires the acquisition of data for each of the relevant or desired competitors or other associated businesses. This has not been done previously for many reasons including the difficulty and cost of obtaining such data. The inventor has discovered that this information is so valuable that it merits the cost and the difficulty in acquiring it. Moreover, once a database of such information is obtained it can be used again reducing its long-term costs. Moreover, such data can be updated at a reasonable cost. So, numeric ratings can be obtained for a number of related businesses or brands and can thus be evaluated and benchmarked against competitors or related businesses.

Example 2 illustrates a simplified managerial report for five automobile dealerships in a geographic region. In this example, an overall value has been determined for each dealership selling a selected brand. In other embodiments the individual scores could be broken out in subgroups that reflect various areas of emphasis measured by the parameters. For example, as well as the overall numerical rating, ratings could be generated that measure the sales atmosphere, the salesmanship skill of the staff, a set of “bottom-line” evaluation questions, and so on. Many other key areas and objective parameters can be addressed.

### EXAMPLE 2

### Dealership Scoring

| Dealership | Total Score |
|---|---|
| 1 | 80 |
| 2 | 82 |
| 3 | 88 |
| 4 | 91 |
| 5 | 76 |

Using the numerical ratings for each of the dealerships, a manager can determine which stores are not up to par and, more particularly, determine which key areas of selected stores are not functioning according to company standards.

More importantly, these dealerships can be benchmarked against other brands or other industries to generate an effective measurement of the dealership.

For example, in Example 3 listed below, a managerial report compares an evaluated retail establishment that sells motorcycles with four competitive brands. In this example, an overall value is measured for the Evaluated Location A and also a similar overall value for each compared brand (here, Ducati, Harley-Davidson, Kawasaki, and BMW). As mentioned above, the individual scores could be broken out in subgroups that reflect various areas of emphasis measured by the parameters.

### EXAMPLE 3

### Dealership Scoring

| Dealership | Total Score |
|---|---|
| Evaluated Location A | 85 |
| Ducati | 80 |
| Harley-Davidson | 95 |
| Kawasaki | 84 |
| BMW | 86 |

This enables the evaluated sales location to be benchmarked against relevant competitors (or other industries or other relevant benchmarking standards) to generate an effective measurement of dealership performance.

One particular measure of benchmarking a business includes the concept of generating a “Prospect Satisfaction Index” value for the evaluated and comparison groups. The Prospect Satisfaction Index is discussed in the following paragraphs.

Again referring to FIG. 1, the operations of defining the set of objective evaluation parameters (Step 103) and assigning weighted values (Step 105) can be further enhanced in some embodiments by calibrating one (or more) of the parameters or calibrating the assigning weighted values so that the rating values more accurately model the evaluation conducted. For example, using information obtained during the evaluation it may become apparent that certain questions or parameters do not model well or alternatively the information may reveal a close relationship between the information and the desired evaluation metric. In the first case the question could be removed or the associated weighting value reduced. In the second case the value of the question can be increased (e.g., or the associated weighting value increased).

For example, in one particular embodiment the evaluation is directed to measuring whether a given sales interaction will result in the generation of revenue (commonly through product sales). Such an evaluation measures a Prospect Satisfaction Index. Calibration is especially helpful in an industry where the sales process is vague, variable, not well understood, lacking in expertise and so on. Calibration can enable the accuracy of the evaluation to be increased. As indicated above (e.g., in Step 103), for example, the process can include defining the set of evaluation parameters as a set of separate steps in a typical industry sales process and using those steps to generate a sales process questionnaire to evaluate how individual shoppers are treated during a sales interaction at an evaluated site. Information is gathered (e.g., in Step 107) including information collected from actual shoppers. For example, this could be conducted using “shopper intercept research” to interrogate real shoppers leaving actual retail locations. A statistically significant sample of such shoppers are interrogated regarding the actual shopping experience. Thus, a database of real shopper information is built up as part of the process. Additionally, other information can be gathered. For example, a sample of mystery shopping information is obtained using a statistically significant sample of “mystery shops”.

Then a calibration is performed comparing the actual shopper database with the mystery shopper (or other information) database. Then statistical modeling can be used to determine the relationship of each answer provided by real shoppers as compared with each answer for the same question obtained from the mystery shoppers. Statistical analysis can be performed on the two (or more) samples and the questions asked of each to determine which questions tend to result in similar answers for the both the mystery shoppers and the real shoppers. Example statistical processes suitable for this evaluation include, but are not limited to correlation analysis, regression analysis, ANOVA (analysis of variance) tests, t-tests, z-tests, Chi-squared tests, R-squared tests, or other statistical tools such as are appropriate. Such statistical analysis can be used to measure the relationship of each answer provided by real shoppers to the answer for the same question provided by mystery shoppers. The findings of such analysis can be used to identify (or otherwise generate) questions where mystery shoppers generate responses to the questions that are substantially the same as that of real shoppers. Such can enable calibration of the test. Worthless or poorly correlated questions can be removed or de-emphasized.

Also, statistical modeling (e.g., of the same sorts as used above) can be used to measure the relationship of these questions to each other to establish which questions are most predictive of shopper responses resulting in an actual sale (or a positive referral that may result in a sale) such as “would recommend this retail location to a friend” or “would purchase from this retail location.” Such questions can be used to evaluate the “salesmanship” of an evaluated site. These questions and others including, but not limited to questions which are associated with industry accepted practices proven to increase the likeliness of selling can be used to generate a suitable questionnaire. In one embodiment this implementation generates a Prospect Satisfaction Index questionnaire.

Additionally, further calibration can be conducted to enhance the accuracy of the Prospect Satisfaction Index so that it is more reflective of how successful the evaluated site will be in generating revenue from each prospect (prospective customer). The inventor points out that “generating revenue from each prospect” can be a widely interpreted term encompassing revenue generated immediately by the shopper, as well as revenue obtained from new shoppers referred by the prospect, and also including the lifetime (future) revenues of the prospect.

As used herein Prospect Satisfaction Index encompasses the frame of mind of the shopper as they leave the evaluated site (e.g., a retail location) and also the salesmanship of the evaluated site. One example of the former is the answer to the question, “Would you buy from this retail location?” An example of the latter, is whether or not the evaluated retail location recorded the shoppers contact information to enable follow-up, or whether or not the retail location provided compelling reasons why the shopper should purchase from that specific retail location.

The inventor also points out that the weighting of the parameters (questions) is done using industry knowledge and/or the statistical modeling and evaluation discussed above.

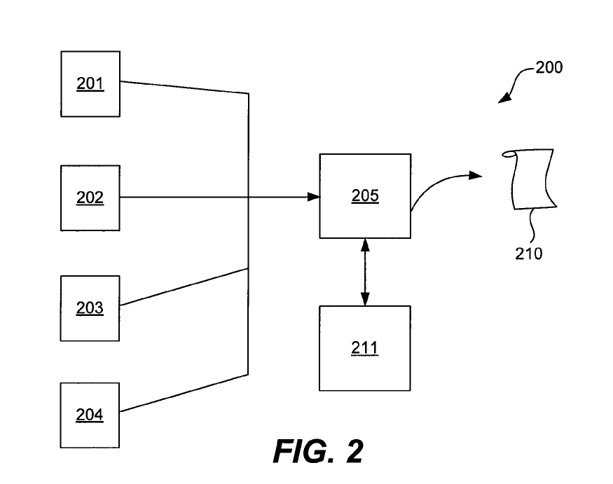

FIG. 2 is a simplified block 200 diagram illustrating a computer system used to execute the software of an embodiment of the invention and suitable for enabling the methods described herein. The system includes a computer system 205 that can include a monitor, keyboard, mouse, and so on. Computer system 205 can include subsystems, such as a plurality of central processors (CPU's) (including cache memory resources), system memory, fixed storage (e.g., hard drives), removable storage (e.g., magnetic drives, CD drives, DVD drives, and so on), display adapters, sound cards and speakers, and network interfaces. The network interface can be used to facilitate connection with many different network structures including the Internet. The computer system 205 can include central processors that, for example, can execute computer program code (e.g., an operating system) to implement the invention. Elements 201-204 depict data collection devices suitable for enabling the collection of the information relevant to the set of objective evaluation parameters (e.g., as in Step 107). These can be anything from paper questionnaires to linked computerized devices. The information is collected and forwarded to the system 205 which processes the information obtained using a set of computer readable instructions to generate ratings (e.g., Step 109). The inventor points out that the computer is not required to implement the invention (it could be done by hand or by any other suitable method if desired) but merely offers one particularly useful embodiment. The data is then processed and a report is generated. The report can comprise a paper report 210 or alternatively can be viewed as a computer file (for example, it can be displayed on a monitor forming part of computer system 205). In yet another alternative, the report can be viewed at a remote location 211 e.g., displayed on a monitor forming part of remote computer system. The remote system can be connected by network interfaces that can be used to facilitate connection with many different network structures including the Internet. Importantly, the principles of the invention can specifically be implemented on networked computer systems having many individual computers. Such networked systems can include local area networks (LAN's) or a wide area network (WAN's). Particularly, the inventors contemplate computer systems and message traffic operating over the Internet. Additionally, an example of a LAN is a private network used by a mid-sized company with a building complex. Publicly accessible WAN's include the Internet, cellular telephone network, satellite systems and plain-old-telephone systems (POTS). Examples of private WAN's include those used by multi-national corporations for their internal information system needs. The network may also be a combination of private and/or public LANs and/or WANs. Computer architectures having many different configurations of subsystems may also be utilized

The invention can use a combination of hardware and software components. The software can be embodied as computer readable code (or computer program code) on a computer readable medium. The computer readable medium is any data storage device that can store data which can thereafter be read by a computer system. Examples of the computer readable medium include read-only memory, random-access memory, DVD's, CD-ROMs, magnetic tape, and optical data storage devices. The computer readable medium can also be distributed over a network coupled computer systems so that the computer readable code is stored and executed in a distributed fashion.

It should be pointed out that the reports generated by the invention can be viewed on local computer terminals, viewed remotely (via a LAN, WAN, or the internet), viewed on small handheld computing devices, and even in paper format. Additionally, it should be pointed out that requests for information or reports can also be accomplished remotely (e.g., the internet) if desired. It should also be pointed out that generating the report can include the generation of a report that tracks the single rating value over time. For example, the rating values can be input into a computer and tracked over two or more specific time periods to generate several sets of data for the same store.

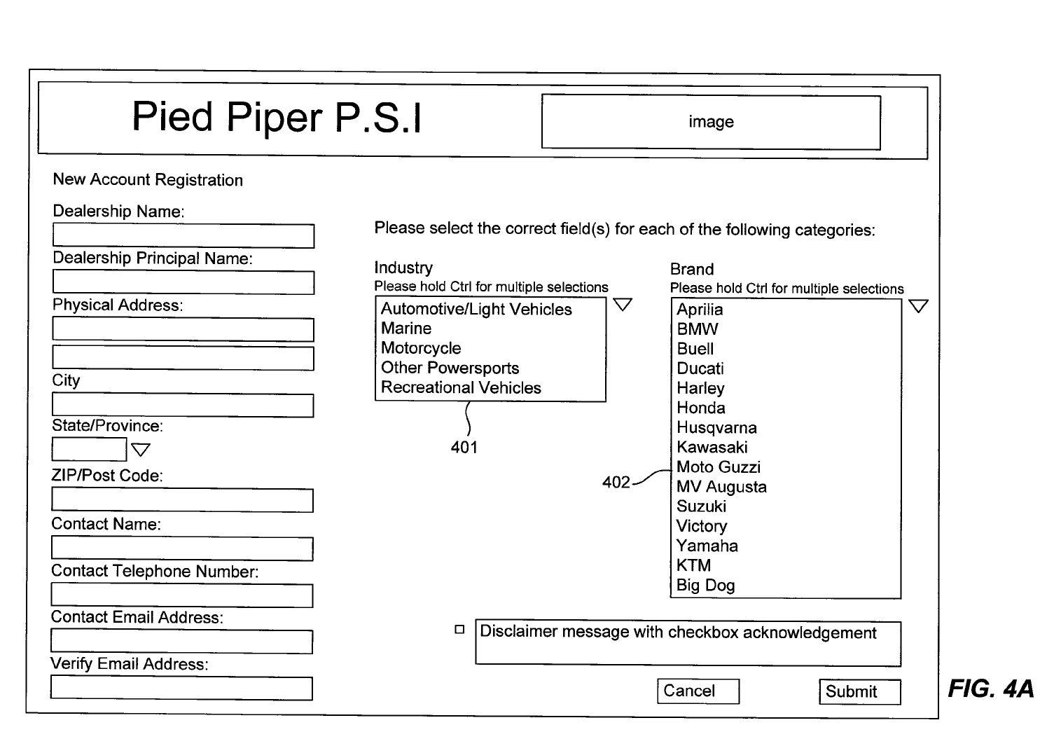

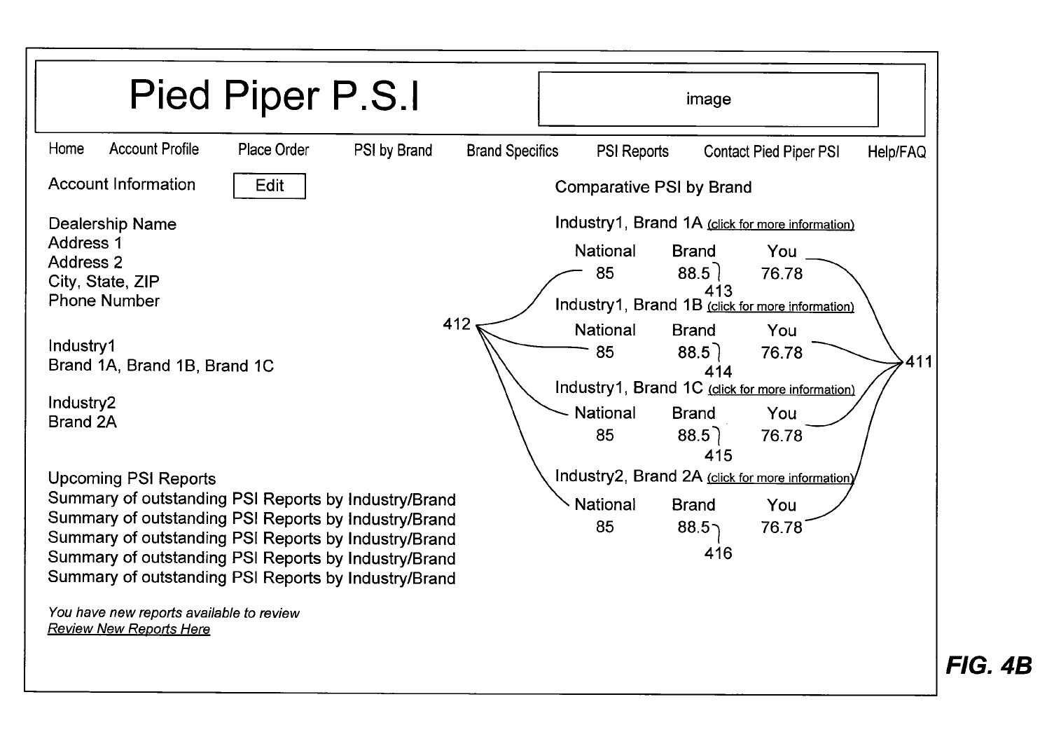

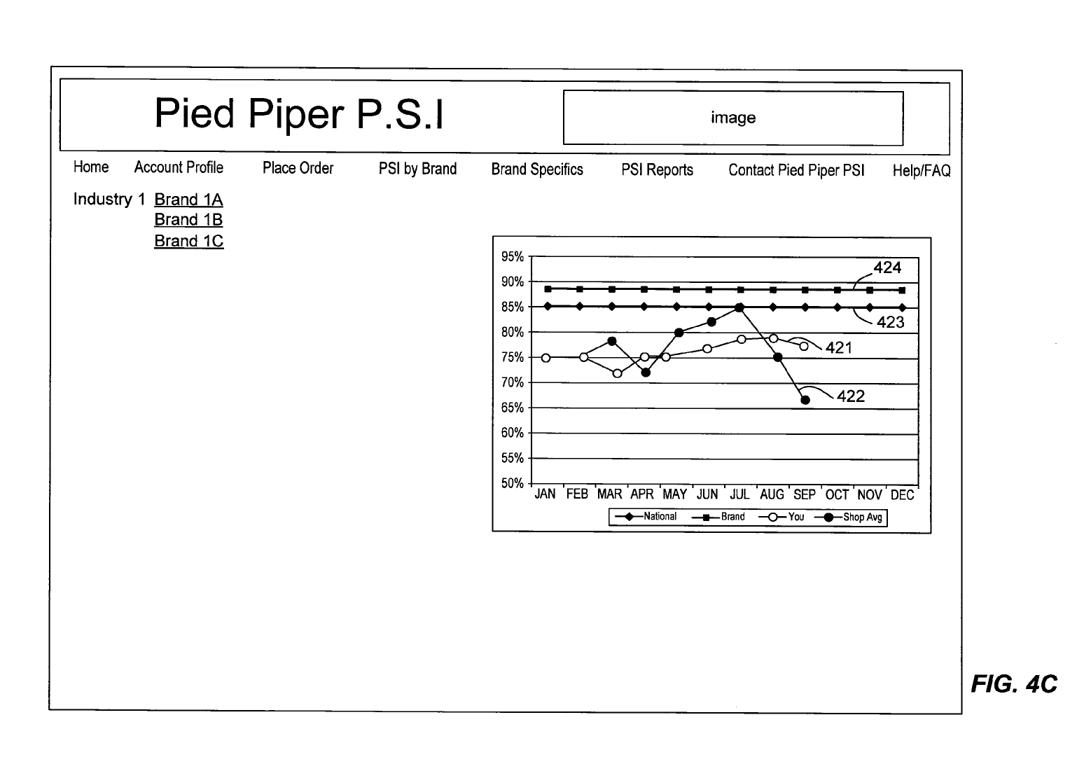

FIG. 4A illustrates one embodiment of a managerial report constructed in accordance with the principles of the invention. A registration page FIG. 4A can be used to select and industry 401 and/or brands 402 for evaluation. Many other fields can be used to identify other information as needed.

FIG. 4B illustrates a simplified embodiment of a managerial report illustrating a comparison of an evaluated set of businesses 411 as compared to the industry as a whole 412 and also as compared to several different brands 413, 414, 415, 416. Many other fields can be used to identify other information as needed.

FIG. 4C presents a managerial report that tracks the rating values of a business operation 421 over a time period. Also tracked are the rating values of a multi-store regional average 422, a national average 423, and a brand average 424. In this example report, the business operation was evaluated once each month for a measured period. This information can be compared to benchmark a business 421 against a number of selected standards. Such a report can enable the identification of weak points in a business operation and identify needs for corrective measures to be taken to make a business operation more productive, if necessary. A graph is used in this managerial report to illustrate peaks and valleys of store operations. In this way, the manager can visually see the high and low points of operations.

The present invention has been particularly shown and described with respect to certain preferred embodiments and specific features thereof. However, it should be noted that the above-described embodiments are intended to describe the principles of the invention, not limit its scope. Therefore, as is readily apparent to those of ordinary skill in the art, various changes and modifications in form and detail may be made without departing from the spirit and scope of the invention as set forth in the appended claims. Other embodiments and variations to the depicted embodiments will be apparent to those skilled in the art and may be made without departing from the spirit and scope of the invention as defined in the following claims. Further, reference in the claims to an element in the singular is not intended to mean “one and only one” unless explicitly stated, but rather, “one or more”. Furthermore, the embodiments illustratively disclosed herein can be practiced without any element, which is not specifically disclosed herein.

We claim:

1. A method for evaluating a business sales environment and associated effects, the method comprising the operations of:
defining a first set of businesses and a second set of businesses, each forming a part of an industry;
defining a set of objective evaluation parameters suitable for evaluating shopping experience concerning the industry;
assigning weighted values to the set of objective evaluation parameters;
obtaining information relevant to the set of objective evaluation parameters, the information suitable for enabling an evaluation of a shopping experience concerning the industry;
generating a rating value for at least one business of the first set of businesses and for at least one business of the second set of businesses by assessing the obtaining information in conjunction with the set of objective evaluation parameters and the associated weighting values; and
generating a report that includes the compared rating values.

2. The method of claim 1 wherein the method is configured to evaluate profitability and revenue generation of a business relative to other businesses, wherein assigning the weighted values to the set of objective evaluation parameters includes using the information obtained to adjust the assigning weighted values so that they more accurately correlate the objective evaluation parameters with revenue generation.

3. The method of claim 1 wherein
defining the first and second set of businesses comprises defining a first business as a business under evaluation wherein the first business sells a product of a first brand and wherein the second set of businesses comprise a set of businesses that sell other brands that compete with the first brand;
obtaining information comprises,
obtaining information concerning the business under evaluation, and
obtaining information concerning businesses that sell the other brands;
generating the rating values includes generating a prospect satisfaction index value for the business under evaluation and a prospect satisfaction index value for the businesses that sell other brands by assessing the obtaining information in conjunction with the set of objective evaluation parameters and the associated weighting values;
comparing said prospect satisfaction index values; and
generating a report that includes the compared prospect satisfaction index values enabling the prospect satisfaction index value for the business under evaluation to be benchmarked against the prospect satisfaction index values for the businesses that sell other brands.

4. The method of claim 1 wherein the operations of defining objective evaluation parameters and assigning weighted values to the set of objective evaluation parameters include calibrating at least one of the parameters or the assigning weighted values so that the rating values more accurately model the actual likelihood of a sale.

5. A computer program product comprising a computer-usable medium having computer-readable code embodied thereon for invoking a method for evaluating a business sales environment and associated effects, the computer program product comprising computer-readable program code for enabling the following steps within a computer system:
defining a first set of businesses and a second set of businesses, each forming a part of an industry
receiving information relevant to a set of objective evaluation parameters, the information suitable for enabling an evaluation of a shopping experience concerning the industry;
assigning weighted values to the set of objective evaluation parameters;
generating a single rating value for the first set of businesses and the second set of businesses by assessing the received information in conjunction with the set of objective evaluation parameters and the associated weighting values;
generating a report that compares rating values.

6. The computer program product of claim 5 wherein said defining of the first and second sets of businesses further includes defining additional sets of businesses which are also compared.

7. The computer program product of claim 5 wherein the set of objective evaluation parameters includes parameters that can be measured by observation or by evaluation using a set of queries associated with the parameters.

8. The computer program product of claim 5 wherein the set of objective evaluation parameters evaluate a sales experience encountered by a shopper.

9. The computer program product of claim 8 wherein the set of objective evaluation parameters are configured to evaluate the salesmanship encountered by a shopper during the sales experience.

10. The computer program product of claim 8 wherein the set of objective evaluation parameters are configured to evaluate the general sales environment encountered by a shopper during the sales experience.

11. The computer program product of claim 5 wherein assigning weighted values to the set of objective evaluation parameters includes calibrating the parameters so that the information received enables the rating value to be accurate predictor of whether customer interactions will result in revenue generation.

12. The computer program product of claim 11 wherein calibrating the parameters is conducted by using obtained from actual customers that made purchases.

13. The computer program product of claim 5 wherein receiving said information includes receiving information obtained from at least one: shopper evaluations, mystery shopping, surveys of actual customers, questionnaires, direct mail surveys, direct evaluation, comment cards, and telephone surveys.

14. The computer program product of claim 13 wherein receiving the information includes requesting shopper evaluations using an internet based information request.

15. The computer program product of claim 13 wherein the report is displayed in a web-based format.

16. The computer program product of claim 5 wherein defining the first and second set of businesses includes defining the first set of businesses as an entire industry and the second set of businesses a set of businesses comprising a portion of said entire industry; and
comparing said rating values comprises comparing the rating value of the first and second set of businesses.

17. The computer program product of claim 16 wherein defining the first and second set of businesses includes defining the first set of businesses as all of the business selling a single brand and the second set of businesses comprising a sub-set of businesses selling said brand.

18. The computer program product of claim 17 wherein defining the second set of businesses includes defining the second sub-set of businesses as a single sales location selling said brand.

19. The computer program product of claim 17 wherein defining the second set of businesses includes defining the second sub-set of businesses as a set of sales locations selling said brand in a specified geographic region.

20. The computer program product of claim 5 wherein generating the report includes presenting the rating values for the first and second sets of businesses as comprising operations within a chain of business operations and forming a managerial report comparing the performance of evaluated business operations within the chain.

21. The computer program product of claim 5 wherein receiving information relevant to the set of objective evaluation parameters further includes adjusting the evaluation parameters and weighted values to correlate responses received from actual purchasing customers with the parameters.

22. A method for evaluating a business, the method comprising:
defining a business segment and at least one associated business segment;
formulating a set of objective evaluation parameters that are applicable to the business segments;
receiving information relevant to the set of objective evaluation parameters;
assigning weighted values to the set of objective evaluation parameters, wherein the weighted values are associated with the relative importance of various aspects of the evaluation parameters;
generating a single rating value associated with the business segment and a single rating value for each of the at least one associated business segments by assessing the received information in conjunction with the set of objective evaluation parameters and the associated weighting values; and
generating a report that includes the compared rating values.

23. The method of claim 22 wherein
formulating the set of objective evaluation parameters includes formulating parameters that can be measured by observation or by evaluation using a set of queries associated with the parameters.

24. The method of claim 22 wherein
formulating the set of objective evaluation parameters applicable to the business segments includes generating parameters that evaluate the sales experience encountered by a shopper.

25. The method of claim 24 wherein the set of objective evaluation parameters are configured to evaluate the salesmanship encountered by a shopper during a sales experience.

26. The method of claim 24 wherein the set of objective evaluation parameters are configured to evaluate the general sales environment encountered by a shopper during a sales experience.

27. The method of claim 24 wherein formulating the objective evaluation parameters includes a further process of calibrating the parameters so that information collected relevant to the evaluation parameters enables rating value to be accurate predictor of whether customer interactions will result in the generation of revenue at some point.

28. The method of claim 27 wherein calibrating the parameters is conducted by using the received information relevant to the set of objective evaluation parameters.

29. The method of claim 28 wherein calibrating the parameters is conducted by using a portion of the received information wherein said portion comprises received information obtained from actual customers that made purchases.

30. The method of claim 22 wherein
receiving information relevant to the set of objective evaluation parameters comprises receiving information obtained using at least one: of questionnaires, shopper evaluations, mystery shopping, surveys of actual customers, direct mail surveys, direct evaluation, comment cards, and telephone surveys.

31. The method of claim 30 wherein receiving the information includes obtaining the information using mystery shopping.

32. The method of claim 30 wherein receiving the information includes requesting the mystery shopping by using an internet based request.

33. The method of claim 22 wherein
receiving information relevant to the set of objective evaluation parameters includes receiving responsive information from shopper evaluations that include at least some actual purchasing customers;
formulating the set of objective evaluation parameters further includes generating a series of queries associated with each of the evaluation parameters.

34. The method of claim 33 wherein formulating the set of objective evaluation parameters includes
providing an initial set of evaluation parameters;
comparing the set of evaluation parameters and queries against responses received from the actual purchasing customers;
performing statistical analysis on responses received from the actual purchasing customers to correlate the responses with the parameters and associated queries; and
if needed, modifying the evaluation parameters and queries and the weighted values to more closely associate them with responses received from the actual purchasing customers so that the set of parameters and queries and the weighted values is more accurately predictive of whether a sale will be generated by interaction with a prospective customer.

35. The method of claim 34 wherein the initial set of evaluation parameters are provided by experts in an industry the subject of the report.

36. The method of claim 34 wherein the initial set of evaluation parameters are provided by consulting published sources of information concerning an industry the subject of the report.

37. The method of claim 34 wherein the initial set of evaluation parameters are provided by using well known industrial information concerning an industry the subject of the report.

38. The method of claim 34 wherein the initial set of evaluation parameters are provided by using previously obtained shopper evaluations relating to an industry the subject of the report.

39. The method of claim 33 wherein formulating the set of objective evaluation parameters includes
providing an initial set of evaluation parameters;
comparing the set of evaluation parameters and queries against responses received from the actual purchasing customers; and
if needed, modifying the evaluation parameters and queries and the weighted values in accordance with the responses received from the actual purchasing customers so that the set of parameters is more accurately predictive whether a sale will be generated by interaction with a prospective customer; and
generating a single rating value further includes generating rating values that can accurately predict the generation of revenue based on responses to the parameters and associated queries.

40. The method of claim 22 wherein
defining the business segment and the at least one associated business segment includes defining the business segment as an entire industry and the at least one associated business segment as a set of businesses comprising a portion of said industry; and
comparing said rating values comprises comparing the rating value of the set of businesses with a rating for the entire industry.

41. The method of claim 22 wherein
defining the business segment and the at least one associated business segment includes defining a first set of businesses and a second set of businesses each forming a part of an industry; and
comparing the rating value comprises comparing a rating value determined for the first set of businesses with a similar rating for the second set of businesses.

42. The method of claim 41 wherein generating a single rating value comprises generating a single rating that evaluates the satisfaction of a prospective customer with a sales experience.

43. The method of claim 42 wherein the single rating value comprises a prospect satisfaction index.

44. The method of claim 41 wherein generating the report comprises generating a report that compares the first set of businesses with the second set of businesses.

45. The method of claim 44 wherein generating the report comprises generating a report that tracks the rating value of the first set of businesses and the rating value of the second set businesses over at least two time intervals.

46. The method of claim 41 wherein the first set of businesses includes all businesses comprising an industry.

47. The method of claim 46 wherein the second set of businesses comprises a plurality of brands within the industry.

48. The method of claim 46 wherein the second set of businesses comprises one brand within the industry.

49. The method of claim 46 wherein the second set of businesses comprises one specific sales location within the industry.

50. The method of claim 46 wherein the first set of businesses comprises a plurality of brands within an industry.

51. The method of claim 50 wherein the second set of businesses comprises another plurality of brands within the industry.

52. The method of claim 41 wherein the first set of businesses comprises all businesses comprising a single brand in an industry.

53. The method of claim 52 wherein the second set of businesses comprises a plurality of sales locations for said brand within a specified geographical region.

54. The method of claim 52 wherein the second set of businesses comprises a single sales location for said brand.

55. The method of claim 41 wherein the first set of businesses comprises all businesses comprising a single brand within a specified geographical region.

56. The method of claim 55 wherein the second set of businesses comprises a specified set of sale locations for said brand.

57. The method of claim 41 wherein the first set of businesses comprises all businesses comprising the motorcycle industry and wherein the second set of businesses includes only those businesses making up a specified motorcycle brand.

58. The method of claim 57 wherein the second set of businesses comprises a set of sales locations for the motorcycle brand.

59. The method of claim 22 wherein
assigning weighted values to the set of objective evaluation parameters is based on the relative predictive importance of a given parameter in determining how important the parameter is in predicting revenue generation.

60. The method of claim 59 wherein assigning weighted values includes assigning said weighed values based on specified concerns raised by a client.

61. The method of claim 59 wherein assigning weighted values take into consideration a correlation of the parameter with one of actual sales and future sale.

62. The method of claim 23 wherein the set of queries associated with the parameters comprise questions composed to require a yes or no response.

63. The method of claim 62 wherein the questions are grouped according to key operation areas of a business operation.

64. The method of claim 22 further including an operation of accessing the report using an internet connection.

65. The method of claim 22 wherein generating the report includes presenting the rating values calculated in a graphical form.

66. The method of claim 64 wherein the report in graphical form includes a graph comparing the rating values over at least two different time intervals.

67. The method of claim 22 wherein generating the report includes presenting the rating values for a plurality of business operations within a chain of business operations and forming a managerial report comparing the performance of evaluated business operations within the chain.

68. The method of claim 67 wherein the report compares the operations of at least two business operations within the chain.

69. The method of claim 67 wherein the report is directed to comparing businesses in the motor vehicle industry.

70. The method of claim 69 wherein the report is directed to comparing businesses in the motorcycle industry.

71. The method of claim 69 wherein the report is directed to comparing businesses in the automotive industry.

72. The method of claim 69 wherein the report is directed to comparing businesses in the recreational vehicle industry.

73. The method of claim 69 wherein the report is directed to comparing businesses in the marine industry.
